(19) United States
(12) Patent Application Publication
(10) Pub. No.: US 2025/0373710 A1
(43) Pub. Date: Dec. 4, 2025

(54) DATA TRANSMISSION METHOD AND ELECTRONIC DEVICE

(71) Applicant: Lenovo (Beijing) Limited, Beijing (CN)

(72) Inventor: Hongcheng XIA, Beijing (CN)

(21) Appl. No.: 19/224,697

(22) Filed: May 30, 2025

(30) Foreign Application Priority Data
May 31, 2024 (CN) 202410705518.9

(51) Int. Cl. H04L 67/75

(52) U.S. Cl. CPC H04L 67/75

(57) ABSTRACT

A data transmission method includes obtaining first data; calling a target intelligence engine, the target intelligence engine being used to generate data consisting of characters; processing the first data to obtain second data based on the target intelligence engine, the second data consisting of character elements; and transmitting the second data, the data volume of the second data being smaller than the data volume of the first data, and the meaning expressed by the first data being similar to the meaning expressed by the second data.

### CROSS-REFERENCES TO RELATED APPLICATION

This application claims priority to Chinese Patent Application No. 202410705518.9 filed on May 31, 2024, the entire content of which is incorporated herein by reference.

### FIELD OF TECHNOLOGY

The present disclosure relates to the field of data processing technology and, more specifically, to a data transmission method and an electronic device.

### BACKGROUND

In conventional technology, data is generally not processed before being transmitted using a transmission protocol, which leads to large amounts of data needing to be transmitted, high resource usage, and long transmission time.

### SUMMARY

One aspect of this disclosure provides a data transmission method. The data transmission method includes a obtaining first data; calling a target intelligence engine, the target intelligence engine being used to generate data consisting of characters; processing the first data to obtain second data based on the target intelligence engine, the second data consisting of character elements; and transmitting the second data. The data volume of the second data is smaller than the data volume of the first data, and the meaning expressed by the first data is similar to the meaning expressed by the second data.

Another aspect of this disclosure provides an electronic device. The electronic device includes a display and a processor. The display is used for displaying the first data. The processor is configured to obtain the first data; call a target intelligence engine, the target intelligence engine being used to generate data consisting of characters; process the first data based on the target intelligence engine to obtain second data, the second data consisting of character elements; transmit the second data. The data volume of the second data is smaller than the data volume of the first data, and the meaning expressed by the first data is similar to the meaning expressed by the second data.

Another aspect of this disclosure provides a computer readable storage medium storing computer instructions, when executed by one or more processors, the computer instructions implement the data transmission method provided in the present disclosure.

### BRIEF DESCRIPTION OF THE DRAWINGS

The following drawings are merely examples for illustrative purposes according to various disclosed embodiments and are not intended to limit the scope of the present disclosure. In the drawings, same or similar reference numerals/characters refer to the same or corresponding parts.

FIG. 1 is a flowchart of a data transmission method according to some embodiments of the present disclosure.

FIG. 2 is a flowchart of the data transmission method according to some embodiments of the present disclosure.

FIG. 3 is a flowchart of the data transmission method according to some embodiments of the present disclosure.

FIG. 4 is a schematic structural diagram of an electronic device according to some embodiments of the present disclosure.

FIG. 5 is a schematic structural diagram of the electronic device according to some embodiments of the present disclosure.

FIG. 6 is a schematic structural diagram of the electronic device according to some embodiments of the present disclosure.

### DETAILED DESCRIPTION

Reference will now be made in detail to exemplary embodiments of the disclosure, which are illustrated in the accompanying drawings. Hereinafter, embodiments consistent with the disclosure will be described with reference to drawings. Further, in the present disclosure, the disclosed embodiments and the features of the disclosed embodiments may be combined under conditions without conflicts. It is apparent that the described embodiments are some but not all of the embodiments of the present disclosure. Based on the disclosed embodiments, persons of ordinary skill in the art may derive other embodiments consistent with the present disclosure, all of which are within the scope of the present disclosure.

In the present disclosure, description with reference to the terms “one embodiment,” “some embodiments,” “example,” “specific example,” or “some examples,” etc., means that specific features described in connection with the embodiment or example, structure, material or feature is included in at least one embodiment or example of the present disclosure. Furthermore, the particular features, structures, materials or characteristics described may be combined in any suitable manner in any one or more embodiments or examples. Furthermore, those skilled in the art may combine the different embodiments or examples described in this specification, as well as the features of the different embodiments or examples, as long as they do not conflict with each other.

In the present disclosure, the terms “first,” “second,” and “third” are only used for descriptive purposes, and should not be understood as indicating or implying relative importance or implying the number of indicated technical features. Thus, a feature described with “first,” “second,” and “third” may expressly or implicitly include at least one of this feature, and the order may be changed according to the actual situations.

Those skilled in the art should understand that unless otherwise defined, all terms (including technical terms and scientific terms) used herein have the same meanings as being understood by those of ordinary skill in the art to which the embodiments of the present application belong. It should also be understood that terms, such as those defined in commonly used dictionaries, should be understood to have meanings consistent with their meaning in the context of the prior art. Unless specifically defined as herein, such terms are not intended to be idealized or overly interpreted.

In conventional technology, data is generally not processed before being transmitted using a transmission protocol, which leads to large amounts of data being transmitted, high resource usage, and long transmission time.

Embodiments of the present disclosure provide a data transmission method. On the one hand, by calling a target intelligent engine to process the obtained first data, the development cost can be reduced since the target intelligent engine is easy to update and maintain; on the other hand, since the amount of the second data is smaller than the first data, which reduces the amount of data to be transmitted, thereby saving computing resources and shortening the time of data transmission to reduce latency. In addition, since the meaning expressed by the first data is similar to the meaning expressed by the second data, the accuracy of the transmitted data is improved and the user experience is enhanced. At the same time, this method can be applied to different electronic devices, which improves the versatility of the data transmission method.

The method provided in the embodiments of the present application can be performed by an electronic device. The electronic device can be a laptop, a tablet computer, a desktop computer, a set-top box, a mobile device (e.g., a mobile phone, a portable music player, a personal digital assistant, a dedicated messaging device, a portable gaming device) and other types of terminals, and can also be implemented as a server. The server can be an independent physical server, or a server cluster or distributed system consisting of multiple physical servers. The server can also be a cloud server that provides basic cloud computing services such as cloud services, cloud databases, cloud computing, cloud functions, cloud storage, network services, cloud communications, middleware services, domain name services, security services, content delivery networks (CDNs), as well as big data and artificial intelligence platforms.

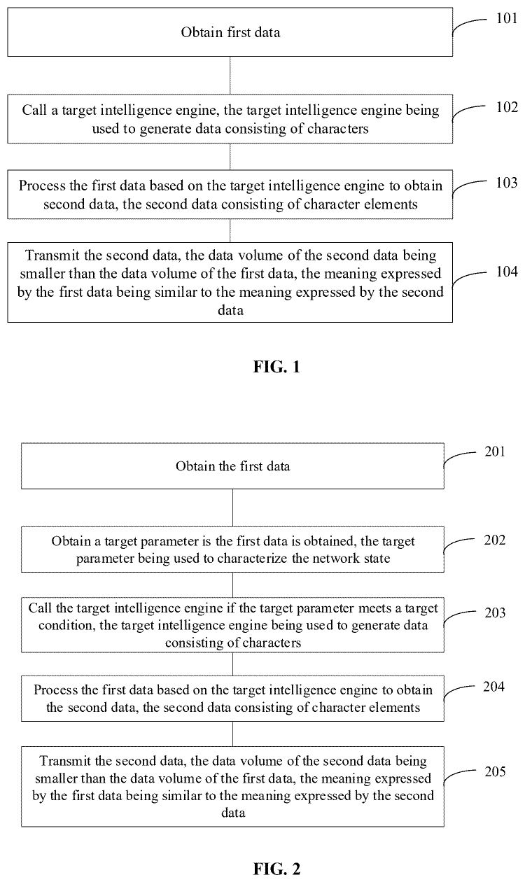

FIG. 1 is a flowchart of a data transmission method according to some embodiments of the present disclosure. The method will be described in detail below.

101, obtaining first data.

The first data may be the initial data that needs to be transmitted. The first data can be any suitable data, such as images, videos, etc. The method of obtaining the first data may include, but is not limited to reading the first data from the current device, reading the first data from the cloud, etc.

In some embodiments, the first data may include characters. Characters may refer to glyph units or symbols, and characters may include, but are not limited to letters, numbers, operation symbols, punctuation marks, etc. The character may be any suitable character, for example, an ASCII character, a Unicode character, etc. In some embodiments, when the first data is an image, the first data may include characters, and the characters may be used to represent the content of the first data.

In some embodiments, the first data may be obtained before the first data is transmitted using a transmission protocol.

102, calling a target intelligence engine, the target intelligence engine being used to generate data consisting of characters.

In some embodiments, the intelligent engine may be a software component or a system that incorporates artificial intelligence technology. The target intelligent engine may include, but is not limited to: a machine learning engine, a generative adversarial network (GAN) engine, an artificial intelligence generated content (AIGC) model, etc. Machine learning can reorganize existing knowledge structures to continuously improve their performance. GAN consists of a generator and a discriminator, and can process input data through adversarial training. AIGC refers to a technology based on artificial intelligence (AI) techniques such as large-scale pre-trained models, which generates relevant content with appropriate generalization capabilities through learning and identifying existing data.

The target intelligent engine can be an Image-to-Text Model. An image-to-text model (e.g., a vision-language model) converts visual information (pixels) into textual descriptions, which involves Visual Feature Extraction and text generation. By applying the target intelligent engine in the solution of the present disclosure, images that occupy a large storage space can be converted into text information that occupies a small storage space for output. Thus, a smaller bandwidth can be required for transmitting the converted text information.

Similarly, the target intelligent engine can be a video-to-text model. A video-to-text model extends image-to-text frameworks to spatial-temporal encoding and narrative generation. The spatial-temporal encoding can extract features from video frames and tracks temporal dynamics. The narrative generation can produce a textual summary of events, actions, or scene changes across frames. By applying the target intelligent engine in the solution of the present disclosure, videos that occupy a large storage space can be converted into text information that occupies a small storage space for output. Thus, a smaller bandwidth can be required for transmitting the converted text information.

In some embodiments, a large amount of training data may be used to train an untrained intelligent engine to obtain a target intelligent engine.

103, processing the first data based on the target intelligence engine to obtain second data, the second data consisting of character elements.

In some embodiments, the second data may be data that needs to be transmitted after conversion. After the second data is received by another device, the second data can be used to regenerated the images or videos using a text-to-image model or a text-to-video model.

Methods for expressing the amount of data may include, but are not limited to: the size of the storage space occupied, the signal strength required to transmit the data, etc. The size of the storage space for the first data may be any appropriate size, for example, 353 KB (kilobytes), 285 KB, etc. The size of the storage space for the second data may be any appropriate size, for example, 3 B (bytes), 2.5 B, etc. The signal strength required for transmitting the first data may be any suitable magnitude, for example, −45 dBm (decibels milliwatt), −52 dBm, etc. The signal strength required for transmitting the second data may be any suitable magnitude, for example, −25 dBm, −30 dBm, etc.

In some embodiments, the larger the storage space occupied by the data, the larger the corresponding data volume. The greater the signal strength required to transmit the data, the larger the corresponding data volume.

In some embodiments, the target intelligent engine may have an optical character recognition (OCR) function. OCR is the process by which electronic devices can examine characters, determine their shapes by detecting dark and light patterns, and then use character recognition methods to translate the shapes into computer text. In some embodiments, when the first data includes characters, the OCR function of the target intelligent engine may be used to extract the characters in the first data to obtain the second data.

In some embodiments, the target intelligent engine may have the function of information recognition and conversion. When the first data includes images but no characters, the information recognition and conversion function of the target intelligent engine may be used to identify the content represented by the first data, and use characters to describe the represented content to obtain the second data.

In some embodiments, when the first data includes images and characters, the characters in the first data can be extracted using the OCR function of the target intelligent engine. Subsequently, the information recognition and conversion function of the target intelligent engine may be used to identify the content represented by other data other than the characters in the first data, and the characters may be used to describe the represented content, and finally all the obtained characters may be used as the second data.

In some embodiments, when extracting characters from the first data using the OCR function of the target intelligent engine, whether the extracted characters are characters describing the first data can be determined. When the extracted characters can describe the characters of the first data, the extracted characters may be used as the second data. When the extracted characters cannot describe the characters of the first data, the extracted characters may not be used as the second data, and other characters that can describe the first data may be used as the second data.

104, transmitting the second data, the data volume of the second data being smaller than the data volume of the first data, the meaning expressed by the first data being similar to the meaning expressed by the second data.

In some embodiments, the transmission method of the second data may include, but is not limited to a communication channel, direct memory access (DMA), a transmission protocol, etc. The communication channel is the path for data transmission. In computer networks, channels are divided into physical channels and logical channels. The communication channel may be any suitable channel, for example, a satellite channel, a mobile hotspot (Wireless Fidelity, WiFi), Bluetooth, a wireless communication network, etc. Direct memory access is a feature provided by some computer bus architectures that enables data from an attached device to be sent directly to the computer's mainboard memory.

The transmission protocol is the rules that must be followed during data transmission. The transmission protocol may be any suitable protocol, for example, the transmission control protocol (TCP), the user datagram protocol (UDP), etc. TCP is a connection-oriented, reliable, byte-stream-based transport layer communication protocol. UDP is a datagram mode that provides packet-switched computer communication in a group of interconnected computer network environments.

In some embodiments, when the distance between the electronic device sending the second data and the electronic device receiving the second data is not greater than a preset distance, the second data can be transmitted via Bluetooth or near-field communication (NFC). The preset distance may be any appropriate distance, for example, 3 cm (centimeter), 2.5 m (meter), etc. Bluetooth is a short-range wireless communication technology that can establish a short-range wireless technology connection for devices to transmit data. NFC is a short-range high-frequency wireless communication technology that allows electronic devices to exchange data when they are close to each other.

In some embodiments, the meaning expressed by the first data being similar to the meaning expressed by the second data may be that the similarity between a first result obtained by semantically describing the first data and a second result obtained by semantically describing the second data meeting a similarity condition. The similarity condition may include, but is not limited to greater than a similarity threshold, close to a similarity threshold, etc. The similarity threshold may be any suitable value, for example, 60%, 85%, etc. For example, the first data may be an image of a kitten eating a fish, and the second data may be characters of “kitten eating fish”. In this case, the meaning expressed by the first data is similar to the meaning expressed by the second data.

Consistent with the present disclosure, on the one hand, by calling a target intelligent engine to process the obtained first data, the development cost can be reduced since the target intelligent engine is easy to update and maintain; on the other hand, since the volume of the second data is smaller than the first data, which reduces the amount of data to be transmitted, thereby saving computing resources and shortening the time of data transmission to reduce latency. In addition, since the meaning expressed by the first data is similar to the meaning expressed by the second data, the accuracy of the transmitted data is improved and the user experience is enhanced. At the same time, this method can be applied to different electronic devices, which improves the versatility of the data transmission method.

In some embodiments, the first data may include a plurality of consecutive frames of images, and the process at 101 may include a process at 11.

11, obtaining a plurality of consecutive frames of images.

The plurality of frames of images may be continuous videos captured by a built-in or external camera device of the electronic device, or may be videos received and transmitted by other electronic devices, etc. The method of obtaining consecutive frames of images may include, but is not limited to reading consecutive frames of images from the current device, reading consecutive frames of images from the cloud, etc.

In some embodiments, the plurality of consecutive frames of images may be obtained before the plurality of consecutive frames of images are transmitted using a transmission protocol.

In some embodiments, the first data may include a plurality of consecutive frames of images, and the process at 103 may include a process at 13.

13, based on the target intelligent engine, processing the plurality of frames of images to obtain the second data, the second data including the characters corresponding to each of the plurality of frames of images.

In some embodiments, the amount of the second data may be smaller than the amount of the consecutive frames of images, and the meanings expressed by the consecutive frames of images may be similar to the meanings expressed by the second data. The size of the storage space for the consecutive frames of images may be any suitable size, for example, 2.2 MB (megabytes), 860 KB, etc. The signal strength required for transmitting the consecutive frames of images may be any appropriate value, for example, −40 dBm, −55 dBm, etc.

In some embodiments, the target intelligent engine may include, but is not limited to a machine learning engine, a GAN engine, an AIGC model, etc.

In some embodiments, each frame of the plurality of consecutive frames of images may be taken as a first data in time sequence. First, each first data may be processed by the target intelligent engine to obtain the corresponding second data; then, each second data may be transmitted in chronological order.

In some embodiments, all consecutive frames of images may be used as the first data. First, the first data may be processed by a target intelligent engine to obtain second data; then, the second data may be transmitted.

Consistent with the present disclosure, the target intelligence engine can process a plurality of frames of images to obtain the second data. On the one hand, the transmission of video data is realized and the application scenarios of the data transmission method is broadened. On the other hand, by transmitting the second data with a small amount of data, the amount of data transmitted is reduced, thereby saving computing resources.

In some embodiments, the second data may include at least one character group, and obtaining the second data in the process at 13 may include the following processes.

131, obtaining a first character group corresponding to the N^{th} frame of image.

The N^{th} frame of image may be any frame of image in the plurality of frames of images. N can be any suitable positive integer, for example, 10, 58, etc. For example, the plurality of frames of images include 30 frames of images, and the N^{th} image frame may be the 5^{th} frame of image in the 30 frames of images.

The first character group may include characters for describing the N^{th} frame of image. In some embodiments, the N^{th} frame of image may be processed based on the target intelligent engine to obtain the first character group. In some embodiments, the characters in the first character group may be characters included in the N^{th} frame of image, or characters obtained by processing the N^{th} frame of image by the target intelligent engine. For the process of the target intelligent engine processing the N^{th} frame of image, reference can be made to the specific implementation of the process at 103.

132, adding a separator.

The separator may be a symbol used to identify the location where characters are separated. The separator may be any suitable symbol, for example, a semicolon, a comma, a space, etc.

The method for adding the separator may include, but is not limited to natural language processing (NLP), preset functions, etc. The function may be any suitable function, for example, a LEFT function, a MID function, etc. The LEFT function is used to return a specified number of characters from a string and add separators between the characters. The MID function can extract a specified number of characters from multiple characters by adding separators. NLP is an important direction in the fields of computer science and artificial intelligence. Through NLP, users can identify the natural breakpoints in multiple characters and add separators at these breakpoints.

In some embodiments, character group after the separator can be in the form of a paragraph, and each segment of characters after the segmentation can be regarded as a character group. For example, a separator may be added between the first character group and the second character group to divide the first character group and the second character group into two paragraphs to achieve segmentation.

133, obtaining a second character group corresponding to the N+1^{th} frame of image.

The N+1^{th} frame of image may be any frame of image in the plurality of frames of images. In some embodiments, N+1^{th} frame of image may be a frame of image that is continuous in time with the N^{th} frame image and is the next frame image. For example, the plurality of frames of images include 10 frames of images, the N^{th} frame of image is the second image frame in the 10 frames of images, and the N+1^{th} frame of image may be the third frame of image.

The second character group may include characters used to describe the N+1th frame of image. For the process of obtaining the second character group, reference can be made to the specific implementation of the process at 131.

Consistent with the present disclosure, by adding a separator between the first character group corresponding to the N^{th} frame image and the second character group corresponding to the N+1^{th} frame image, on the one hand, the content of each frame of the image can be accurately described, thereby improving the accuracy of transmitting a plurality of frames of images; on the other hand, compared with converting a plurality of frames of images into a plurality of second data for transmission, only one second data is required to transmit the plurality of frames of images, thereby shortening the time required to transmit data.

FIG. 2 is a flowchart of the data transmission method according to some embodiments of the present disclosure. The method will be described in detail below.

201, obtaining the first data.

The process at 201 corresponds to the process at 101. During implementation, reference can be made to the specific implementation of the process at 101.

202, obtaining a target parameter is the first data is obtained, the target parameter being used to characterize the network state.

The target parameter may be a parameter that characterizes the network state. The target parameter may be any suitable parameter, such as bandwidth, signal strength, etc. Bandwidth may refer to the amount of data that can pass through a link per unit time. The bandwidth may be any suitable size, for example, 30 KB/s (kilobytes per second), 10 MB/s (megabytes per second), etc. Signal strength may refer to the strength of the signal used by the device. Signal strength may be any suitable value, for example, −40 dBm, −65 dBm, etc.

The method for obtaining target parameters may include, but is not limited to calling a preset interface, reading a target page, etc. The preset interface may be any suitable interface, for example, an operator interface, an interface of a speed measurement tool, etc. Speed test tools can measure the speed of the network connection by downloading and uploading blocks of data and provide an approximation of the bandwidth. The target page may be any page that appropriately includes the target parameter, such as a device management page, a network connection page, etc.

203, calling the target intelligence engine if the target parameter meets a target condition, the target intelligence engine being used to generate data consisting of characters.

The target condition may be any appropriate condition, for example, not greater than a target value, less than a target value, close to a target value, etc. The target value may be any suitable value, such as a target bandwidth value, a target signal strength value, etc. The target bandwidth value may be any suitable size, such as 5 KB/s, 30 B/s (bytes per second), etc. The target signal strength value may be any suitable size, such as −60 dBm, −57 dBm, etc.

In some embodiments, the target parameter and the corresponding target value may be of the same type. For example, when the target parameter is bandwidth, the target value is the target bandwidth value. In another example, when the target parameter is signal strength, the type of the target value is a target signal strength value.

In some embodiments, if the target parameter does not meet the target condition, the first data may be directly transmitted. The transmission method of the first data may include, but is not limited to communication channel, DMA, transmission protocol, etc.

For the process of calling the target intelligence engine, reference can be made to the specific implementation of the process at 102.

204, processing the first data based on the target intelligence engine to obtain the second data, the second data consisting of character elements.

205, transmitting the second data, the data volume of the second data being smaller than the data volume of the first data, the meaning expressed by the first data being similar to the meaning expressed by the second data.

The processes at 204 and 205 correspond to the processes at 103 and 104. During implementation, reference can be made to the specific implementation of the processes at 103 and 104.

Consistent with the present disclosure, the process of calling the target intelligent engine is performed when the target parameter obtained meets the target conditions, which improves the accuracy and flexibility of the data transmission method.

In some embodiments, the process at 205 may include a process at 25.

25, transmitting the second data based on the target communication channel if the target parameter meets the target condition.

The target communication channel may be any suitable channel, for example, a satellite channel, Wi-Fi, Bluetooth, a wireless communication network, etc. A wireless communication network refers to a network that can interconnect various communication devices without the need for wiring. A wireless communication network may be any suitable network, such as a wireless wide area network (WWAN), a wireless local area network (WLAN), a wireless metropolitan area network (WMAN), and a wireless personal area network (WPAN).

Consistent with the present disclosure, the second data is transmitted based on the target communication channel only when the target parameter meets the target condition, thereby improving the accuracy of the second data transmission.

In some embodiments, the target parameter may represent the network state of the target communication channel, and the target parameter may include at least one of the signal strength of the target communication channel, and the bandwidth of the target communication channel. In some embodiments, the process at 25 in which the target parameter meets the target condition may include a process at 25a.

25a, the target parameter being less than the target value indicates that the target parameter meets the target condition.

The target value may be any suitable value, for example, a target bandwidth value, a target signal strength value, etc. The target bandwidth value may be any suitable value, for example, 5 KB/s, 30 B/s, etc. The target signal strength value may be any suitable value, for example, −60 dBm, −57 dBm, etc.

For example, when the target parameter is 2 KB/s and the target bandwidth value is 3 KB/s, the target parameter is less than the target bandwidth value. In this case, the target parameter can be considered as meeting the target condition.

In some embodiments, when the target parameter meets the target conditions, the target intelligent engine can be called to process the first data to obtain the second data, where the amount of the second data is less than the amount of the first data. By reducing the amount of data, data can be transmitted using the same target communication channel.

Consistent with the present disclosure, when the target parameter is less than the target value, the target parameter is considered as meeting the target condition, thereby improving the accuracy of the data transmission method.

In some embodiments, the target parameter may represent the network state of a first type of communication channel. The target parameter may include at least one of the signal strength of the first type of communication channel, and the bandwidth of the first type of communication channel. In some embodiments, the process at 25 in which the target parameter meets the target condition may include a process at 25b, and the process at 25 in which the second data is transmitted may include a process at 251.

25b, the target parameter being less than the target value indicates that the target parameter meets the target condition.

The first type of communication channel may be any suitable channel, for example, a satellite channel, Wi-Fi, Bluetooth, a wireless communication network, etc. The signal strength of the first type of communication channel may be any appropriate value, for example, −75 dBm, −50 dBm, etc. The bandwidth of the first type of communication channel may be any appropriate value, for example, 2 KB/s, 30 B/s, etc. The target value may be any suitable value, for example, a target bandwidth value, a target signal strength value, etc.

251, transmitting the second data through a second type of communication channel.

The second type of communication channel may be any suitable channel, for example, a satellite channel, Wi-Fi, Bluetooth, a wireless communication network, etc. The signal strength of the second type of communication channel may be any appropriate value, for example, −45 dBm, −58 dBm, etc. The bandwidth of the second type of communication channel may be any appropriate value, for example, 20 KB/s, 1 MB/s, etc.

In some embodiments, the second type of communication channel and the first type of communication channel may be communication channels of different types. The signal strength of the second type of communication channel may be greater than the signal strength of the target communication channel.

Consistent with the present disclosure, when the target parameter meets the target condition, the second data can be transmitted through the second type of communication channel with a stronger signal strength, thereby improving the speed and efficiency of transmitting the second data and enhancing the user experience.

In some embodiments, the target parameter may represent the network state of the target communication channel in a first network standard, and the target parameter may include at least one of the signal strength of the target communication channel in the first network standard, and the bandwidth of the target communication channel in the first network standard. In some embodiments, the process at 25 in which the target parameter meets the target condition may include a process at 25c, and the process at 25 in which the second data is transmitted may include processes at 2501 and 2502.

25c, the target parameter being less than the target value indicates that the target parameter meets the target condition.

The network standard is the type of network. The first network standard may include, but is not limited to, the second generation mobile communication technology (2G), the third generation mobile communication technology (3G), the fourth generation mobile communication technology (4G), the fifth generation mobile communication technology (5G), etc.

The signal strength of the target communication channel in the first network standard may be any appropriate value, for example, −76 dBm, −48 dBm, etc. The bandwidth of the target communication channel in the first network standard may be any suitable size, for example, 7 KB/s, 50 B/s, etc. The target value may be any suitable value, for example, a target bandwidth value, a target signal strength value, etc.

2501, switching the network stand of the target communication channel to a second network standard.

The second network standard may include, but is not limited to 2G, 3G, 4G, etc. In some embodiments, the signal strength under the second network standard may be greater than the signal strength under the first network standard.

The method of switching the network standard to the second network standard may include, but is not limited to fallback operation, switching technology, etc. The implementation method of the fallback operation may include, but is not limited to evolved packet system fallback (EPSFB), circuit switched fallback (CSFB), etc. EPSFB and CSFB are fallback mechanisms in the field of communications, which can be used to implement the switching of network formats. The switching technology refers to the technology of switching network formats. In some embodiments, the switching technology may include hard switching and soft switching.

2502, transmitting the second data based on the target communication channel being in the second network standard.

In some embodiments, when the target communication channel is in the second network format, the second data may be transmitted through DMA or a transmission protocol.

For example, when the first network standard is 5G and the target parameter is less than the target value, the network standard of the target communication channel may be switched to the second network standard. The second network standard may be 2G. After switching to the second network standard, the second data may be transmitted by sending a text message.

Consistent with the present disclosure, when the target parameter meets the target condition, the second data can be transmitted through the target communication channel in the second network standard, thereby ensuring the transmission of the second data and improving the flexibility of the data transmission method.

The following describes the application of the data transmission method provided in the embodiments of the present application in a practical scenario. Take the transmission of an image (corresponding to the first data described above) by an electronic device as an example.

In conventional technology, data is generally not processed before being transmitted using a transmission protocol, which leads to large amount of data being transmitted, high resource usage, and long transmission time.

Consistent with the present disclosure, on the one hand, by calling a target intelligent engine to process the obtained first data, the development cost can be reduced since the target intelligent engine is easy to update and maintain; on the other hand, since the volume of the second data is smaller than the first data, which reduces the amount of data to be transmitted, thereby saving computing resources and shortening the time of data transmission to reduce latency. In addition, since the meaning expressed by the first data is similar to the meaning expressed by the second data, the accuracy of the transmitted data is improved and the user experience is enhanced. At the same time, this method can be applied to different electronic devices, which improves the versatility of the data transmission method.

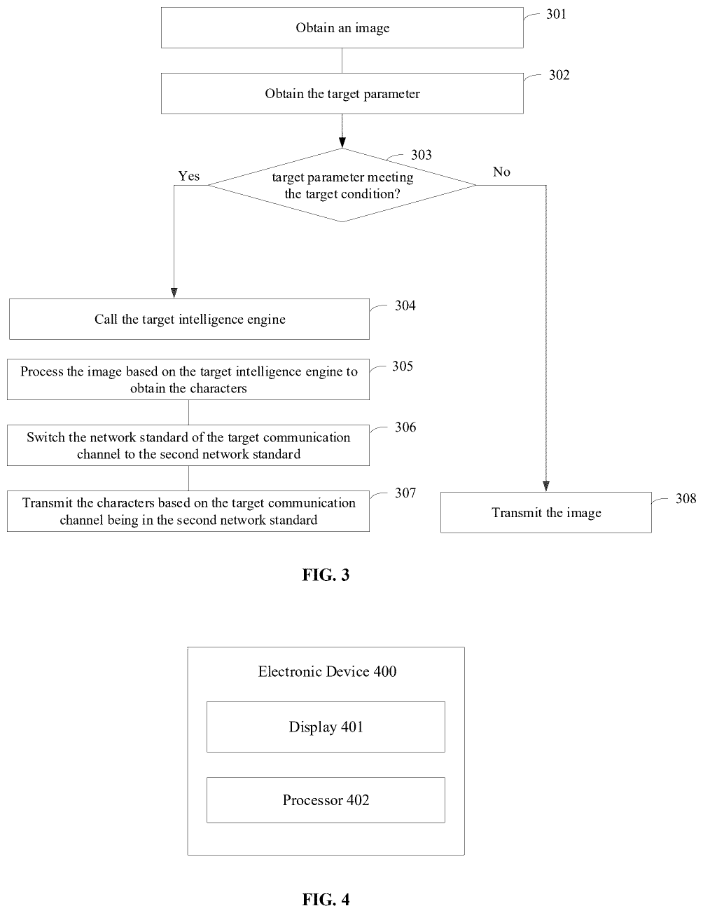

FIG. 3 is a flowchart of the data transmission method according to some embodiments of the present disclosure. The method will be described in detail below.

301, obtaining an image.

302, obtaining the target parameter.

303, determining whether the target parameter meets the target condition; if so, proceed to the process at 304; otherwise, proceed to the process at 308.

304, calling the target intelligence engine.

305, processing the image based on the target intelligence engine to obtain the characters (corresponding to the second data described above).

306, switching the network standard of the target communication channel to the second network standard.

307, transmitting the characters based on the target communication channel being in the second network standard.

308, transmitting the image.

Based on the above embodiments, the present application also provides an electronic device. FIG. 4 is a schematic structural diagram of an electronic device 400 according to some embodiments of the present disclosure. As shown in FIG. 4, the electronic device 400 includes a display 401 and a processor 402.

In some embodiments, the display 401 may be used for displaying the first data.

In some embodiments, the processor 402 may be configured to obtain the first data and call the target intelligence engine, the target intelligence engine being used to generate data consisting of characters; process the first data based on the target intelligence engine to obtain the second data, the second data consisting of character elements; transmit the second data, the data volume of the second data being smaller than the data volume of the first data, the meaning expressed by the first data being similar to the meaning expressed by the second data.

The display may be a display tool that displays first data on a screen. The display may be any suitable display, for example, a liquid crystal display (LCD), an organic light-emitting diode display (OLED), a mini-LED display, a micro-LED display, etc.

The first data can be any suitable data, such as images, videos, etc. The method of obtaining the first data may include, but is not limited to reading the first data from the current device, reading the first data from the cloud, etc. The target intelligent engine may include, but is not limited to a machine learning engine, a GAN engine, an AIGC model, etc.

In some embodiments, the target intelligent engine may be located in the local memory of the electronic device or in the cloud. When the target intelligent engine needs to be called, the target parameter representing the network status can be first obtained. When the target parameter meets the preset condition, the target intelligent engine located in the cloud can be called; when the target parameter does not meet the preset condition, the target intelligent engine located in the local storage can be called. The preset condition may be any appropriate condition, for example, the target parameter is less than a preset value, the target parameter is approximately a preset value, etc.

In some embodiments, the target intelligent engine may be loaded on a processor, which may be the processor 402 or a second processor. The performance of the second processor may be higher than the performance of the processor 402. The target intelligent engine may be loaded and called through the processor.

For the specific process of the processor obtaining the first data, reference can be made to the specific implementation of the process at 101.

For the specific process of the processor calling the target intelligence engine, reference can be made to the specific implementation of the process at 102.

For the specific process of the processor processing the first data to obtain the second data based on the target intelligence engine, reference can be made to the specific implementation of the process at 103.

Consistent with the present disclosure, on the one hand, by calling a target intelligent engine to process the obtained first data by the processor, the development cost can be reduced since the target intelligent engine is easy to update and maintain; on the other hand, since the volume of the second data is smaller than the first data, which reduces the amount of data to be transmitted, thereby saving computing resources and shortening the time of data transmission to reduce latency. In addition, since the meaning expressed by the first data is similar to the meaning expressed by the second data, the accuracy of the transmitted data is improved and the user experience is enhanced. At the same time, this method can be applied to different electronic devices, which improves the versatility of the data transmission method.

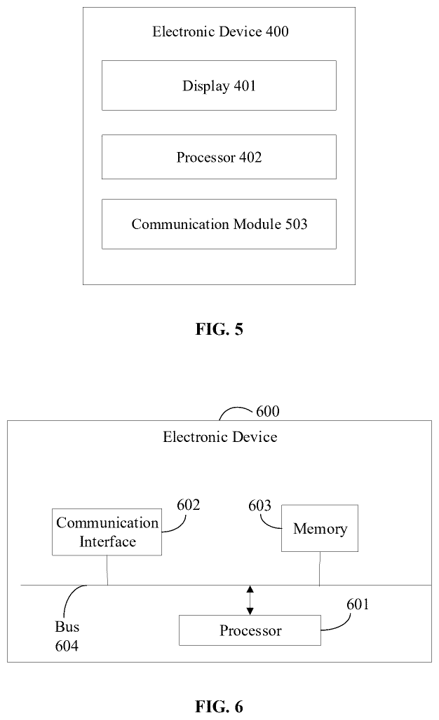

FIG. 5 is a schematic structural diagram of the electronic device 400 according to some embodiments of the present disclosure. As shown in FIG. 5, the electronic device 400 includes a display 401, a processor 402 and a communication module 503.

In some embodiments, the electronic device also includes a communication module 503. The communication module 503 may be used to transmit data.

In some embodiments, the processor 402 may be further configured to obtain a target parameter if the first data is obtained, the target parameter being used to characterize the network state; if the target parameter meets the target condition, perform the process of calling the target intelligent engine.

The communication module may be a hardware used to realize data transmission and communication between devices to ensure the accurate sending and receiving of data. The communication module may be any suitable module, for example, a wireless communication module, an Ethernet communication module, a communication interface module, etc. A wireless communication module is a communication module that can transmit data via wireless signals. The Ethernet communication module is a module used to realize the communication between electronic equipment and Ethernet. The communication interface module is a module used to realize the communication between electronic equipment and external interface.

The target parameter may be any suitable parameter, such as bandwidth, signal strength, etc. The bandwidth may be any suitable value, such as 30 KB/s, 10 MB/s, etc. The signal strength may be any suitable value, such as −40 dBm, −65 dBm, etc.

The method for obtaining the target parameters may include, but is not limited to calling a preset interface, reading a target page, etc. The preset interface may be any suitable interface, such as an operator interface, an interface of a speed test tool, etc. The target page may be any suitable page, such as a device management page, a network connection page, etc.

The target condition may be any appropriate condition, for example, not greater than a target value, less than a target value, close to a target value, etc. The target value may be any suitable value, such as a target bandwidth value, a target signal strength value, etc.

In some embodiments, if the target parameter does not meet the target condition, the first data may be directly transmitted. The transmission method of the first data may include, but is not limited to communication channel, DMA, transmission protocol, etc.

Consistent with the present disclosure, on the one hand, data is transmitted through the communication module, which ensures the stability of the transmitted data; on the other hand, the processor will perform the process of calling the target intelligent engine only when the target parameters obtained meet the target conditions, which improves the accuracy and flexibility of the data transmission method.

In some embodiments, the processor may be further configured to transmit the second data based on the target communication channel using the communication module if the target parameter meets the target condition.

In some embodiments, the target parameter may represent the network state of the target communication channel, and the target parameter may include at least one of the signal strength of the target communication channel, and the bandwidth of the target communication channel. In this case, the processor may be configured to indicate that the target parameter meets the target condition when the target parameter is less than the target value.

In some embodiments, the target parameter may represent the network state of the target communication channel, and the target parameter may include at least one of the signal strength of the target communication channel, and the bandwidth of the target communication channel. In the case, the processor may be configured to indicate that the target parameter meets the target condition when the target parameter is less than the target value; and to transmit the second data through the second type of communication channel by using the communication module.

In some embodiments, the target parameter may represent the network state of the target communication channel in a first network standard, and the target parameter may include at least one of the signal strength of the target communication channel in the first network standard, and the bandwidth of the target communication channel in the first network standard. In this case, the processor may be configured to indicate that the target parameter meets the target condition when the target parameter is less than the target value; switch the network standard of the target communication channel to a second network standard; and transmit the second data by using the communication module based on the target communication channel being in the second network standard.

In some embodiments, the processor may be further configured to obtain a plurality of consecutive frames of images; process the plurality of frames of images based on the target intelligent engine to obtain the second data, the second data including characters corresponding to each of the plurality of frames of images.

In some embodiments, the processor may be further configured to obtain a first character group corresponding to the N^{th} frame image; add a separator; and obtain a second character group corresponding to the N+1^{th} frame of image.

The descriptions of the above device embodiments are similar to the descriptions of the above method embodiments, and have similar beneficial effects to the method embodiments. For technical details not disclosed in the apparatus embodiments of the present disclosure, reference may be made to the descriptions of the method embodiments of the present disclosure for understanding.

Each embodiment in this specification is described in a progressive mode, and each embodiment focuses on the difference from other embodiments. Same and similar parts of each embodiment may be referred to each other. As for the device disclosed in the embodiments, since it corresponds to the method disclosed in the embodiments, the description is relatively simple, and for relevant details, the reference may be made to the description of the method embodiments.

It should be noted that when the display control method mentioned above is implemented in a form of a software functional module and sold or used as an independent product, the functions may be stored in a computer-readable storage medium. Based on such an understanding, the technical solutions of the present disclosure essentially, or the part contributing to the prior art, or a part of the technical solutions may be implemented in a form of a software product. The computer software product is stored in a storage medium and includes several instructions for instructing an electronic device to perform all or a part of the steps of the methods described in the present disclosure. The foregoing storage medium includes: any medium that can store program code, such as a USB flash drive, a removable hard disk, a read-only memory (ROM), a magnetic disk, or an optical disc. In this way, the embodiments of the present disclosure are not limited to any particular combination of hardware and software.

The present application provides an electronic device including a memory and a processor. The memory stores a computer program that, when executed by the processor, causes the processor to implement the computer program.

The present disclosure also provides a computer-readable storage medium.

The storage medium may be used to store a computer program. When the computer program is executed, methods provided by various embodiments of the present disclosure may be achieved. The computer-readable storage medium may be transitory or non-transitory.

The present disclosure also provides a computer program product. The computer program product includes a non-transitory computer-readable storage medium storing a computer program. When the computer program is read and executed by a computer, some or all of the steps in the above method can be implemented. The computer program product may be implemented in hardware, software or a combination thereof. In some embodiments, the computer program product may be embodied as a computer storage medium. In other embodiments, the computer program product may be specifically manifested as a software product, such as a software development kit (SDK), etc.

FIG. 6 is a schematic structural diagram of an electronic device 600 according to some embodiments of the present disclosure. As shown in FIG. 6, the electronic device 600 includes a processor 601, a communication interface 602 and a memory 603.

The processor 601 generally controls the overall operation of the electronic device 600. The communication interface 602 enables the electronic device to communicate with other terminals or servers through a network. The memory 603 can be configured to store instructions and applications executable by the processor 601, and can also cache data to be processed or processed by the processor 601 and various modules in the electronic device 600 (for example, image data, audio data, voice communication data, and video communication data), which can be implemented through a flash memory (FLASH) or a random-access memory (RAM). Data can be transmitted between the processor 601, the communication interface 602 and the memory 603 via a bus 604.

It should be noted here that the description of the above storage medium and device embodiments is similar to the description of the above method embodiments, and has similar beneficial effects as the method embodiments. For technical details not disclosed in the storage medium and device embodiments in the present disclosure, reference can be made to the description of the method embodiments of the present disclosure.

In the present disclosure, description with reference to the terms “one embodiment,” “some embodiments,” “example,” “specific example,” or “some examples,” etc., means that specific features described in connection with the embodiment or example, structure, material or feature is included in at least one embodiment or example of the present disclosure. Furthermore, the particular features, structures, materials or characteristics described may be combined in any suitable manner in any one or more embodiments or examples. Furthermore, those skilled in the art may combine the different embodiments or examples described in this specification, as well as the features of the different embodiments or examples, without conflicting each other. In various embodiments of the present disclosure, the size of the sequence numbers of the above-mentioned processes does not mean the sequence of execution, and the execution sequence of each process should be determined by its functions and internal logic, rather than the implementation process of the embodiments of the present disclosure. The above-mentioned serial numbers of the embodiments of the present application are only for description, and do not represent the advantages or disadvantages of the embodiments.

In the present disclosure, the terms “comprising,” “including” or any other variation thereof are intended to encompass a non-exclusive inclusion such that a process, method, article or device comprising a list of elements includes not only those elements, but also others not expressly listed elements, or also include elements inherent to such a process, method, article or apparatus. Without further limitation, an element qualified by the phrase “comprising a . . . ” does not preclude the presence of additional identical elements in a process, method, article or apparatus that includes the element.

In the embodiments provided in the present disclosure, it should be understood that the disclosed device and method may be implemented in other ways. For example, the apparatus embodiments described above are only illustrative. For example, the division of the units is only a logical function division, and there may be other divisions in actual implementation. For example, multiple units or components may be combined or can be integrated into another system, or some features can be ignored or not implemented. In addition, the displayed or discussed mutual coupling or direct coupling or communication connection may be indirect coupling or communication connection through some interfaces, devices or units, and may also be electrical, mechanical or other forms of connection.

The units described as separate components may or may not be physically separated, and the components displayed as units may or may not be physical units, that is, they may be located in one place, or they may be distributed on multiple network units. Some or all of the units may be selected according to actual needs to achieve the objectives of the solutions of the embodiments of the present disclosure.

In addition, the functional units in the various embodiments of the present disclosure may be integrated into one processing unit, or each unit may exist alone physically, or two or more units may be integrated into one unit. The above-mentioned integrated unit can be implemented in the form of hardware or software functional unit.

A person of ordinary skill in the art can be aware that all or part of the processes in the method embodiments of the present disclosure can be implemented by hardware related to the program instructions. The program may be stored in a computer-readable storage medium. When the program executes, the processes of the method embodiments may be executed. The aforementioned storage medium includes: a mobile storage medium, a read-only memory (ROM), a magnetic disk, an optical disk, or another medium that can store program codes.

When the integrated unit is implemented in the form of a software functional unit and sold or used as an independent product, it can be stored in a computer-readable storage medium. Based on this understanding, all or part of the technical solution can be embodied in the form of a software product. The computer software product is stored in a storage medium, and includes several instructions to enable a computer device (which may be a personal computer, a server, or a network device, etc.) to perform all or part of the steps of the method described in each embodiment of the present disclosure. The aforementioned storage medium includes: a mobile storage medium, a read-only memory (ROM), a magnetic disk, an optical disk, or another medium that can store program codes.

Various embodiments have been described to illustrate the operation principles and exemplary implementations. It should be understood by those skilled in the art that the present disclosure is not limited to the specific embodiments described herein and that various other obvious changes, rearrangements, and substitutions will occur to those skilled in the art without departing from the scope of the disclosure. Thus, while the present disclosure has been described in detail with reference to the foregoing embodiments, the present disclosure is not limited to the above described embodiments, but may be embodied in other equivalent forms without departing from the scope of the present disclosure, which is determined by the appended claims.

What is claimed is:

1. A data transmission method comprising:
obtaining first data;
calling a target intelligence engine, the target intelligence engine being used to generate data consisting of characters;
processing the first data to obtain second data based on the target intelligence engine, the second data consisting of character elements; and
transmitting the second data, wherein:
data volume of the second data is smaller than the data volume of the first data, and meaning expressed by the first data is similar to the meaning expressed by the second data.

2. The method of claim 1, before calling the target intelligence engine, the method further comprising:
obtaining a target parameter if the first data is obtained, the target parameter being used to characterize a network state; and
performing the process of calling the target intelligence engine if the target parameter meets a target condition.

3. The method of claim 2, wherein transmitting the second data includes:
if the target parameter meets the target condition, transmitting the second data based on a target communication channel.

4. The method of claim 3, wherein:
the target parameter represents the network state of the target communication channel, and the target parameter includes at least one of a signal strength of the target communication channel and a bandwidth of the target communication channel; and
the target parameter meeting the target condition includes:
the target parameter being less than a target value, which indicates that the target parameter meets the target condition.

5. The method of claim 3, wherein:
the target parameter represents the network state of a first type of communication channel, and the target parameter includes at least one of a signal strength of the first type of communication channel and a bandwidth of the first type of communication channel;
the target parameter meeting the target condition includes:
the target parameter being less than a target value, which indicates that the target parameter meets the target condition; and
transmitting the second data includes:
transmitting the second data through a second type of communication channel.

6. The method of claim 3, wherein:
the target parameter represents the network state of the target communication channel in the first network standard, and the target parameter includes at least one of a signal strength of the target communication channel in a first network standard and a bandwidth of the target communication channel in the first network standard;
the target parameter meeting the target condition includes:
the target parameter being less than a target value, which indicates that the target parameter meets the target condition;
transmitting the second data includes:
switching the network standard of the target communication channel to a second network standard; and
transmitting the second data based on the target communication channel being in the second network standard.

7. The method of claim 1, wherein obtaining the first data includes:
obtaining a plurality of consecutive frames of images; and
processing the first data based on the target intelligence engine to obtain the second data includes:
processing the plurality of frames of images based on the target intelligence engine to obtain the second data, the second data including the characters corresponding to each of the plurality of frames of images.

8. The method of claim 7, wherein obtaining the second data includes:
obtaining a first character group corresponding to a N^{th} frame of image;
adding a separator; and
obtaining a second character group corresponding to a N+1^{th} frame of image.

9. The method of claim 1, wherein the target intelligent engine includes at least one of an image-to-text model or a video-to-text model.

10. An electronic device comprising:
a display, the display being used to display first data;
a processor, the processor being configured to obtain the first data; call a target intelligence engine, the target intelligence engine being used to generate data consisting of characters; process the first data based on the target intelligence engine to obtain second data, the second data consisting of character elements; transmit the second data, wherein:
data volume of the second data is smaller than the data volume of the first data, and meaning expressed by the first data is similar to the meaning expressed by the second data.

11. The electronic device of claim 10, further comprising:
a communication module, the communication module being configured to transmit data, wherein:
the processor is further configured to obtain a target parameter if the first data is obtained, the target parameter being used to characterize a network state; perform the process of calling the target intelligence engine if the target parameter meets a target condition.

12. The electronic device of claim 11, wherein the processor is further configured to:
transmit the second data based on a target communication channel if the target parameter meets the target condition.

13. The electronic device of claim 12, wherein:
the target parameter represents the network state of the target communication channel, and the target parameter includes at least one of a signal strength of the target communication channel and a bandwidth of the target communication channel; and
the processor is further configured to:
indicate that the target parameter meets the target condition when the target parameter is less than a target value.

14. The electronic device of claim 12, wherein:
the target parameter represents the network state of a first type of communication channel, and the target parameter includes at least one of a signal strength of the first type of communication channel and a bandwidth of the first type of communication channel;
the processor is further configured to:
indicate that the target parameter meets the target condition when the target parameter is less than a target value; and
transmit the second data through a second type of communication channel.

15. The electronic device of claim 12, wherein:
the target parameter represents the network state of the target communication channel in the first network standard, and the target parameter includes at least one of a signal strength of the target communication channel in a first network standard and a bandwidth of the target communication channel in the first network standard;
the processor is further configured to:
indicate that the target parameter meets the target condition when the target parameter is less than a target value;
switch the network standard of the target communication channel to a second network standard; and
transmit the second data based on the target communication channel being in the second network standard.

16. The electronic device of claim 10, wherein the processor is further configured to:
obtain a plurality of consecutive frames of images; and
process the plurality of frames of images based on the target intelligence engine to obtain the second data, the second data including the characters corresponding to each of the plurality of frames of images.

17. The electronic device of claim 16, wherein the processor is further configured to:
obtain a first character group corresponding to a N^{th} frame of image;
add a separator; and
obtain a second character group corresponding to a N+1^{th} frame of image.

18. The electronic device of claim 10, wherein the target intelligent engine includes at least one of an image-to-text model or a video-to-text model.

19. A computer readable storage medium storing one or more computer instructions, when executed by one or more processors, the computer instructions implementing a data transmission method, the method comprising:
obtaining first data;
calling a target intelligence engine, the target intelligence engine being used to generate data consisting of characters;
processing the first data to obtain second data based on the target intelligence engine, the second data consisting of character elements; and
transmitting the second data, wherein:
data volume of the second data is smaller than the data volume of the first data, and meaning expressed by the first data is similar to the meaning expressed by the second data.

20. The method of claim 19, wherein the target intelligent engine includes at least one of a an image-to-text model or a video-to-text model.
